(19) United States
(12) Patent Application Publication
(10) Pub. No.: US 2006/0143071 A1
(43) Pub. Date: Jun. 29, 2006

(54) Methods, systems and mediums for scoring customers for marketing

(75) Inventor: Glenn Hofmann, Chicago, IL (US)

Correspondence Address: WILMER CUTLER PICKERING HALE AND DORR LLP, 399 PARK AVENUE, NEW YORK, NY, 10022, US

(73) Assignee: HSBC North America Holdings Inc., Prospect Heights, IL (US)

(21) Appl. No.: 11/149,642

(22) Filed: Jun. 10, 2005

Related U.S. Application Data
(60) Provisional application No. 60/636,128, filed on Dec. 14, 2004.
(60) Provisional application No. 60/665,604, filed on Mar. 25, 2005.

(51) Int. Cl. G07G 1/00

(52) U.S. Cl. 705/10

(57) ABSTRACT

Methods, systems, and mediums for calculating a score that predicts customer activity in the future such as whether the customer will make a purchase, visit a store, etc., or how much money the customer will spend, how many times the customer will shop, etc., are provided. In certain embodiments, these methods and systems collect demographic data and transactional data for customers, summarize at least on variable in the demographic data and the transactional data and attach the summary data to each customer, apply a statistical algorithm to the demographic data, the transactional data, and the summary data to create a model of a target variable related to customer activity and/or loyalty, derive a score for each of the customers from the model, select some of the customers based on the scores, and market directly to the selected customers.

### CROSS REFERENCE TO RELATED APPLICATIONS

This application claims the benefit of U.S. Provisional Patent Applications Nos. 60/636,128, filed Dec. 14, 2004, and 60/665,604, filed Mar. 25, 2005, which are both hereby incorporated by reference herein in their entireties.

### FIELD OF THE INVENTION

The present invention relates generally to techniques for gauging whether customers and potential customers will take certain actions in the future. More particularly, the present invention relates to techniques for calculating a score that predicts customer activity in the future such as whether the customer will make a purchase, visit a store, etc., or how much money the customer will spend, how many times the customer will shop, etc.

### BACKGROUND OF THE INVENTION

Customer relationship management often attempts to predict future customer behavior. It is desirable to know how individuals and groups of customers will respond to marketing or other initiatives of a product or service. This response is a driving factor when developing strategies of how and when to market to different groups of customers.

When selecting targets for specific direct marketing events, analysts often try to predict the likelihood of an individual customer response. It is frequently desired to include the customers in the event who have the highest response rates. Common techniques of selection include schemes based on one or a small number of variables representing past behavior (e.g., spend, number of transactions, type of transactions, frequency of activity, time since last activity), the classical Recency, Frequency, Monetary (RFM) scheme, and response models analyzing a similar marketing event from the past.

Selections based on a single variable, or a small number of variables (e.g., choosing all retail customers who have shopped in the last six months), although easy to implement, are typically not very powerful in terms of resulting Return On Investment (ROI).

The classical RFM scheme (which consists of dividing the customers in quintiles in each of the three dimensions and subsequently choosing certain parts of the resulting 125 segments), while somewhat more powerful than single- or few-variable based selections, is often difficult to implement because it is unclear as to which segments to choose, and how to choose within segments if certain target numbers are desired. Many of the existing variations of the classical RFM scheme have similar characteristics. Moreover, although both RFM and single-variable-based selection have the advantage of universality (i.e., they are independent of the specific marketing event that is being planned), which implies that they can be calculated once (within certain intervals) and used for all desired selections, with this convenience comes the disadvantage of reduced precision, since they are based on at most three variables.

Because response models can be based on a multitude of variables available on a customer level, if based on events similar to an upcoming effort, they tend to predict the results of that effort more precisely than single-variable and RFM schemes. However, for this same reason, response models tend to be less universal than these schemes. Moreover, response models require a significantly larger effort to develop, which often makes them impractical to use for every type of marketing event a business may want to execute.

Other data based approaches to customer relationship management include lifecycle management and behavioral/demographic segmentations. The management of these customer segments is customer-centered, and, hence, represents an important advance over product-based management. However, because these segments are based on demographics, a few discrete behaviors, or the life-stage of the customer, these segments tend not to directly align with future behavior.

Thus, an approach that explicitly pursues the target of future customer activity is needed, such that the population can be segmented accordingly.

### SUMMARY OF THE INVENTION

In accordance with the present invention, techniques for calculating a score that predicts customer activity in the future such as whether the customer will make a purchase, visit a store, etc., or how much money the customer will spend, how many times the customer will shop, etc., are provided. Techniques for using this score are also provided. Furthermore, the present invention encompasses systems that calculate and use the score.

In certain embodiments of the invention, methods for scoring customers for marketing are provided. These methods include: collecting demographic data and transactional data for each of the customers; summarizing at least one variable in the demographic data and/or the transactional data to form summary data, and attaching the summary data to each of the customers; applying a statistical algorithm to the demographic data, the transactional data, and the summary data to create a model of a target variable related to customer activity and/or loyalty; deriving a score for each of the customers from the model; selecting at least some of the customers based on the score; and marketing directly to the selected customers.

In other embodiments of the invention, systems for scoring customers for marketing are provided. These systems include: at least one database containing demographic data and transactional data for each of the customers; a computer that receives from the at least one database the demographic data and the transactional data, summarizes at least one variable in the demographic data and/or the transactional data to form summary data, and attaches the summary data to each of the customers, applies a statistical algorithm to the demographic data, the transactional data, and the summary data to create a model of a target variable related to customer activity and/or loyalty, and derives a score for each of the customers from the model; selects at least some of the customers based on the score for each of the customers; and markets directly to the selected customers.

In yet other embodiments of the invention, computer readable mediums are provided. These mediums include instructions being executed by a computer, the instructions including a software application for scoring customers for marketing, the instructions for implementing the steps of: collecting demographic data and transactional data for each of the customers; summarizing at least one variable in the demographic data and/or the transactional data to form summary data, and attaching the summary data to each of the customers; applying a statistical algorithm to the demographic data, the transactional data, and the summary data to create a model of a target variable related to customer activity and/or loyalty; deriving a score for each of the customers from the model; selecting at least some of the customers based on the score; and marketing directly to the selected customers.

### BRIEF DESCRIPTION OF THE DRAWINGS

Various objects, features, and advantages of the present invention can be more fully appreciated as the same become better understood with reference to the following detailed description of the present invention when considered in connection with the accompanying drawings, in which:

FIG. 1 depicts at least one example of an overall process for obtaining activity scores for current customers in accordance with certain embodiments of the present invention;

FIG. 2 depicts at least one example of a process for creating a predictor variable data set (used in steps 112 and 124 of the overall process of FIG. 1) in accordance with certain embodiments of the present invention;

FIG. 3 depicts at least one example of a process for summarizing (rolling up) customer-level data to a group level (used in steps 244, 256, 268 of the process of FIG. 2) in accordance with certain embodiments of the present invention;

FIG. 4 depicts at least one example of a general process for applying activity scores in marketing in accordance with certain embodiments of the present invention;

FIG. 5 depicts at least one example of a typical direct marketing application of activity scores in accordance with certain embodiments of the present invention;

FIG. 6 depicts at least one example of an attrition prevention marketing campaign applying activity scores in accordance with certain embodiments of the present invention;

FIG. 7 depicts at least one example of a marketing campaign applying activity scores towards early enrolment of certain customers in a Gold/Rewards/Loyalty program in accordance with certain embodiments of the present invention;

FIG. 8 depicts at least one example of a marketing campaign applying activity scores towards preventing attrition from a Gold/Rewards/Loyalty program in accordance with certain embodiments of the present invention; and

FIG. 9 depicts at least one example of a system that may used to implement various embodiments of the present invention.

### DETAILED DESCRIPTION OF THE INVENTION

As described above, in accordance with various embodiments of the present invention, techniques are provided for creating customer-level activity scores that express with one number per customer the magnitude of his/her future activity. Techniques are also provided for applying these scores in marketing. Furthermore, the present invention encompasses systems that calculate and use the score.

More particularly, various embodiments contemplated by the present invention envision obtaining customer scores that state the predicted activity level of each customer during a future time period (e.g., the next 12 months). Just like credit scores provide a single number expressing a customer's risk of loan default, the scores of the present invention give a single number expressing future customer activity, and, hence, by strong association, may also predict the susceptibility of a customer to marketing. These scores can be as beneficial for marketing in various industries as credit scores are today for the lending business. The scope of this approach may only be limited by the availability of customer data. Thus, for example, with data from one retailer, one can score all of its customers. Similarly, for example, with data from all department and specialty stores, one, such as a tender provider like Visa or MasterCard, or a participant to a data sharing agreement, can score all shoppers and provide an industry-wide marketing tool.

A statistical model may be used to obtain the scores provided by the present invention. For example, certain implementations may use parametric models, such as logistic regression models, a linear regression model, a non-linear regression model, a generalized linear model, generalized estimating equations, linear discriminant analysis, and quadratic discriminant analysis. As another example, certain implementations may use non-parametric models such as neural networks, support vector machines, nearest-neighbor models, non-parametric regression models, a spline model, a kernel model, a patient rule induction method, and a tree algorithm. Where the model uses a tree algorithm, CART, CHAID, TreeNet, Random Forests, or any other suitable tree algorithm may be used.

A target variable may be used to measure activity. For example, a target variable may be binary, e.g., a flag indicating whether there is activity in 12 months—thus indicating whether a customer is likely to be active or inactive may be used. Other binary events may include: a customer engaging in a given number of transactions in a given period; a customer spending a given amount in the given period, a customer making a given number of retail visits in the given period; a customer qualifying for a loyalty program; a customer showing purchase activity in a given period; and a customer purchasing or subscribing to a certain combination of products. Other target variables that may also be used may be numeric, e.g., the number of transactions, the number of purchases, the number of retailer visits, the number of products and/or subscriptions bought, the spending volume, the number of visits to a Web site, the number of purchases of at least a certain amount, or any combination of these.

Variables for predicting a value for this target variable (i.e., predictor variables) may include past customer transactions, demographic data, account information, and any other relevant data available on a customer level. It may also be desirable to adjust, transform, and derive additional variables from these predictor variables to increase their predictive value. In addition, the predictor variable, as adjusted and/or transformed, and any derivatives, may be summarized at various levels (e.g., retail store, transaction location, zip code, county, state, country, population cluster, etc.), and these summaries attached to each customer in the respective category—hence creating additional predictor variables, which may improve prediction. For categorical base variables, the summary variables may be absolute frequency and/or relative frequency of every level in the variables, for example. For continuous base variables, the summary variables may be mean, standard deviation, and quantiles, for example.

As will be appreciated by one of ordinary skill in the art, the activity scores (i.e., prediction of target variable results) provided by the present invention may be valuable marketing tools, especially for direct marketing. For example, for a typical marketing event, one may want to select the customers with the highest scores, which may translate into higher response rates and sales volume. Use of activity scores in this way may provide a substantial increase in ROI when compared to less advanced selection methods. The scores may also enable targeting of specific customer-lifecycle and activity segments, and, therefore, facilitate a variety of marketing strategies. For example, an attrition prevention strategy could be implemented by direct marketing to active customers with low or declining scores.

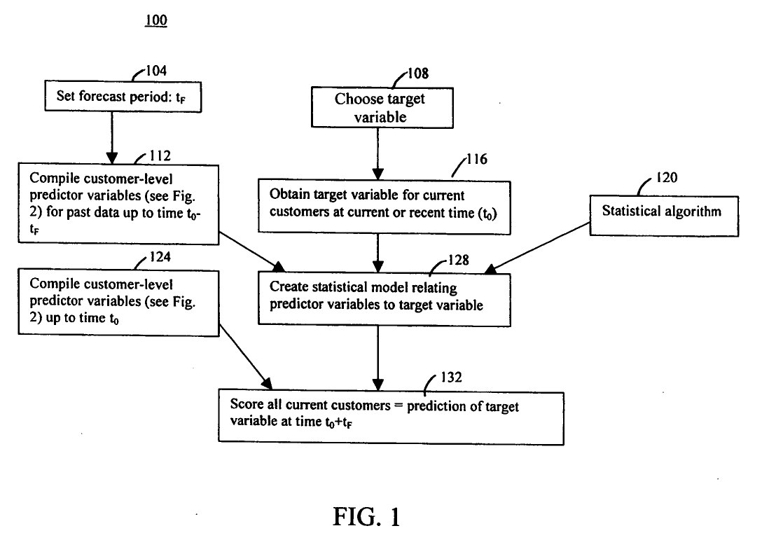

FIG. 1 illustrates at least one example of a process 100 utilizable to create a customer-level activity score that is part of the present invention. Process 100 commences by choosing a target variable at step 108. The target variable is the variable that is going to be predicted for each customer and is related to activity for that customer. Next, a forecast time period t_{F} is set in step 104. The forecast time period is the time into the future that the prediction is desired to apply to.

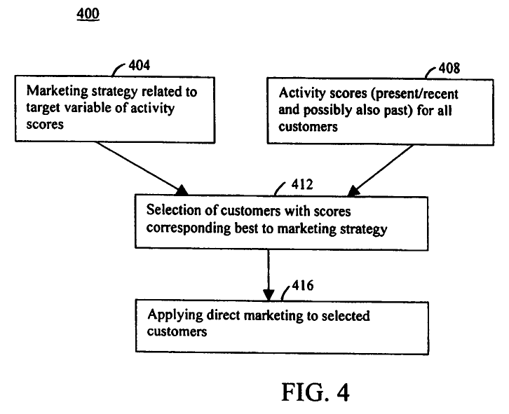

The target variable is preferably chosen at step 108 to measure customer activity. The specific choice depends on the goals of the implementation and therefore any suitable target variable may be chosen. At least some embodiments of the present invention may use as a target variable a flag for customer activity (e.g., the flag may indicate that the customer is (or has been predicted to be) active/not active in a certain time period), the number of transactions made by the customer, the number of purchases made by the customer, the number of (retail) visits by the customer, the number of products bought by the customer, the purchase volume of the customer, or any other suitable metric. A flag for customer activity or the number of visits by the customer may be chosen because these targets are generally good proxies for marketing response (see the discussion of FIGS. 4-8 below). Depending on the nature of the business and the frequency of transactions, numbers of transactions made, purchases made, or products bought by the customer might similarly be good proxies for marketing response. For example, the target variable may relate to the number of independent customer decisions, for example, to go to the store, to buy a subscription, to sign up for a service, etc. In other cases, purchase volume or other money-based target variables may be more appropriate. For example, this may be the case when a volume-related customer classification is desired and volume is not necessarily correlated with frequencies of transactions. It is to be understood that at least some embodiments of the present invention may use activity targets other than the ones explicitly discussed here.

The forecast time periods t_{F} selected at step 104 may be set according to a specific objective of a specific implementation of the invention. Several points may be considered in making this selection. For example, it may be desirable that t_{F} be a meaningful time period for the particular business or application, and be at least large enough that this process of score creation can be carried out and applied to the desired task. In such case, t_{F} preferably will be large enough such that the universality of the activity scores can be taken advantage of, i.e., each scoring can serve several applications. As another example, because only customer data up to the current time to minus t_{F} can be used for model fitting (see the description accompanying step 128 below) t_{F} may need to be small enough to ensure the existence of such data. Although not strictly necessary, it may be desirable to have customer data for at least some members of the population going back at least as far as t₀−2×t_{F} and hence to have a time interval of historical data to be used for modeling of at least length t_{F} (i.e., at least the interval from t₀−2×t_{F} to t₀₋ₜ_{F} should be used). More history can likely improve the precision of the model, and may therefore be preferable. In businesses where seasonal variation is sizable, selecting a time period t_{F} large enough to encompass them proportionally may be desirable. For example, where summer sales differ greatly from winter sales, or holiday sales from non-holiday sales, choosing a forecast period of one year may represent all seasons appropriately. One embodiment of this invention may use t_{F} equal to one year for example. However, for a fast-moving business an adequate forecast period may be a fraction of a day, whereas for a slower moving one, multiples of decades may be more appropriate.

After setting the forecast time period and the target variable at steps 104 and 108, input elements for the statistical model fit may be prepared at steps 112, 116, and 120. At step 116, the target variable may be obtained or calculated for all customers at the current time, or at the most recent time point for which the target variable is available. This time point may be denominated t₀. (Thus, at this particular step/point in time, the target variable is calculated or obtained rather than being predicted.) At step 120, a statistical algorithm may be chosen and at step 112, predictor variables may be prepared.

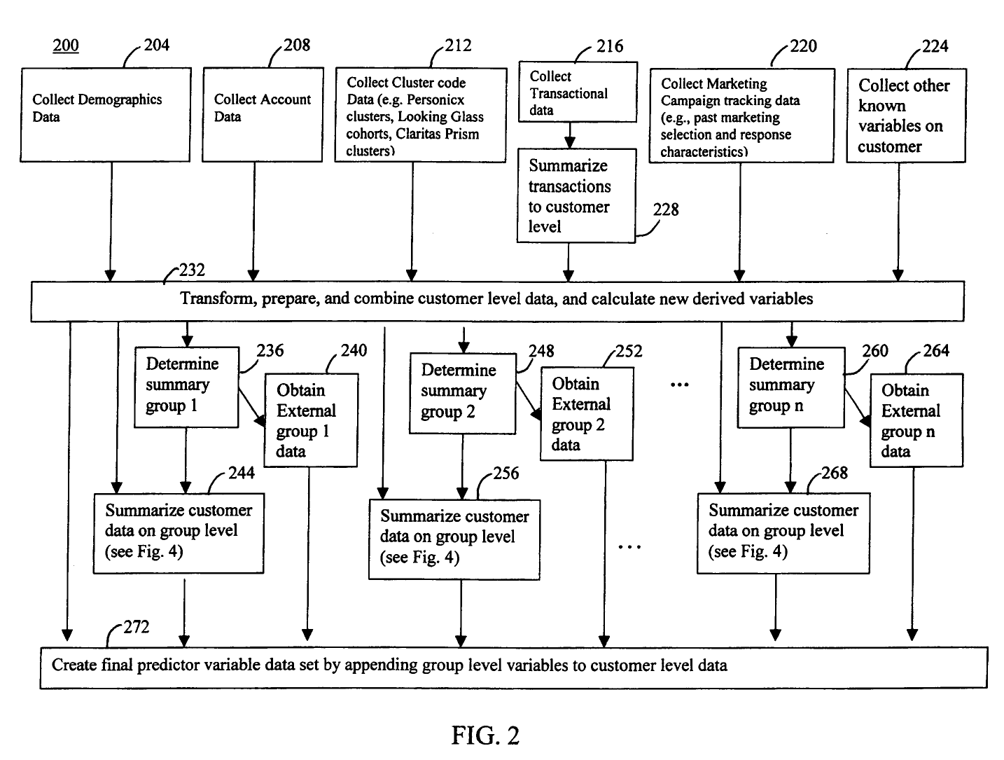

An example of a process 200 for the creation of the predictor variables at step 112 is outlined in FIG. 2. This, or a similar process, may also be used in step 124 of FIG. 1. As shown in FIG. 2, at least some embodiments of this invention may use one or more of the base data sets shown being collected at steps 204, 208, 212, 216, 220, 224 and none, one, or more of the group base data sets shown being collected at steps 240, 252, . . . 264 to create the final predictor variable data set at step 272. Although some embodiments may employ all of these base data sets, this is not necessary for the successful implementation of the invention. Questions to consider when deciding whether to include certain data in the process may include the strength of the relationship with the target variable (the stronger the relationship, the more useful the data may be), and the possibility, ease, or cost of making the data available. The strength of the relationship with the target (i.e., predictiveness) of the different data sets depends on the nature of the business and the customer population.

Turning more particularly to the steps of FIG. 2, the demographic data collected at step 204 may contain customer demographics or psychographics, such as, but not limited to, age, gender, income, marital status, media preferences, existence of certain items, services or people in household for individual customers, business characteristics such as size, category, etc. for commercial customers or any other suitable demographic data, for example. The account data collected at step 208 may contain information related to a customer account, for example, current balance, account age, customer preferences, do-not-solicit information, past payment behavior, service level, services or products bought or subscribed to, or any other suitable account data. The cluster code data collected at step 212 for individuals or households may contain the cluster number assignment from one of the common household-level segmentations, such as but not limited to ACXIOM'S PERSONICX, LOOKING GLASS' COHORTS, CLARITAS' PRISM, ESRI'S COMMUNITY, EXPERIAN'S MOSAIC, MAPINFO'S PSYTE or any other suitable cluster code data. Because common household level segmentations may be the result of models based on demographics, psychographics, consumption information, and/or lifestyle information, these segmentations may be less predictive than direct demographic and transactional data of the customers. However, for some implementations of the invention, these segmentations may be valuable sources of input. The transactional data collected at step 216 may be the most predictive piece of input data because the target variable represents future activity, which tends to have a stronger relationship with past activity (e.g., transactional data) than with demographics or cluster codes. Since transactional data usually contains one record per transaction, it may be summarized on a customer level (i.e., to one record per customer) at step 228. Thus, step 228 may create variables such as but not limited to the number of transactions or retail visits by each customer during certain time periods, locations of transactions, types of items or services purchased, time since the last transaction or last of a certain type of transactions, total transaction amounts, or amounts in certain categories and time periods. It may be useful to create a number of predictive variables in this step. If in doubt, it is typically better to err on the side of more variables rather than less because variables can typically be dropped later in the model fitting step if found not significant for predicting the target variable. The marketing information collected at step 220 from the marketing campaign tracking database may contain information about marketing administered previously to each customer and their responses to these efforts. Other possibly relevant data for customers may be collected at step 224.

Next, at step 232, the variables from the input data sets collected at steps 204, 208, 212, 216, 220, 224, and 228 may be prepared to serve as predictor variables in a statistical model. This step may determine what information the statistical model will be able to use. Quantitative knowledge about the problem and the data may be used to automatically select useful information based on preprogrammed parameters, or any other suitable process, or manually select useful information based upon user input. Some of the variables may need to be adjusted, transformed, converted from discrete to continuous values, or from continuous to discrete values, and combined or used to create new derived variables.

There are generally two aspects to keep in mind when creating variables at step 232. First, variables are preferably predictive of the target variable. At least some implementations of this invention may create large numbers of variables, including many that are suspected of being predictive. When in doubt, one may elect to err on the side of more variables. If the variables later turn out not to be predictive, the statistical model will usually remove them or weigh them down, without increasing the overall prediction error. Second, variables are preferably robust with respect to the time for which they are obtained—i.e., they should have the same meaning and predictive characteristics at times t₀ and t₀−t_{F}, and also at different times t₀ or t₀−t_{F} for different reruns of this process. Seasonal variations may present challenges to robustness. For example, total purchases in the voluminous month of December may be less predictive of January activity than June purchases are of July activity. Similarly, a $x purchase in December could have a very different meaning from a $x purchase in January. Hence, the variable “total purchases during the last month” may be predictive but not robust. However, it may be possible to make the variable robust, for example, by modifying it to “total purchases during the last month divided by average customer purchases during the last month.” This transformation will adjust for seasonal volume differences while hopefully maintaining most of the relevant information about the customer that was contained in the variable. Thus, at step 232, a customer-level data set (one record per customer) with a fairly sizable number of variables may be constructed.

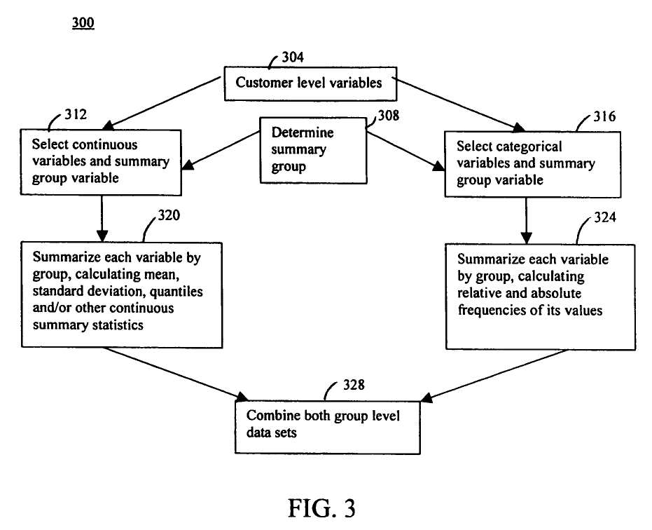

The remaining steps in FIG. 2 may be used to further improve the result of the process. To add further predictive value to the customer-level data set (i.e., the data set with one record per variable for each customer), one or several group variables may be determined for each customer at steps 236, 248, . . . 260. Examples of possible group variables are retail store or transaction location, home zip code, county, state, country or other geographic subdivision, population cluster or demographic segment. Depending on the context of application of the scores, other meaningful group variables may also be determined. These group variables may then be made part of the customer-level data set obtained at step 232. For each group variable, two data sets can potentially be obtained. First, in steps 240, 252, . . . 264, external group-level data may be obtained, where “external” refers to data not directly related to the specific customers. This data may characterize the group or the group population in general, and may be provided by the census bureau, a credit bureau, a market research company or any other source. Just as in step 232, this data may need to be adjusted, transformed, or converted from discrete to continuous values, or from continuous to discrete values, and combined or used to create new derived variables. Second, in steps 244, 256, 268, a second group-level data set may be created by summarizing the customer-level data. An example process 300 of these steps is detailed in FIG. 3.

As shown in FIG. 3, customer-level variables may be split into continuous variables at step 312 and categorical variables at step 316. The continuous variables may then be rolled up into the group variables at step 320 by calculating the mean, median, standard deviation, quantiles and/or other statistics for each group level existing among the customers. Note that if the number of variables is large and computational speed a concern, it may be possible to calculate mean and standard deviation faster than the median or other quantiles, and in at least some embodiments of this invention, they may suffice. Similarly, the categorical variables may also be rolled up into the group variables at step 324 by calculating both the absolute and relative frequencies of each of their categories. For each categorical base variable, this may create a number of new variables equal to twice the number of categories. For variables with a large number of categories, it may be desirable to consolidate the most infrequent categories into one “other” category. This can be done generally by setting a threshold relative frequency of, for example 10% or 5%, and consolidating all categories that are below the threshold for the entire data set (all group values). It may not be desirable to apply thresholding separately within group values in the “other” category because the meaning of the “other” category may be inconsistent. Lastly, in step 328, all created group level variables may be combined.

Turning back, to process 200 illustrated in FIG. 2, finally at step 272, this process may create the final customer-level predictor variable data set by matching group-level data obtained at steps 240, 244, 252, 256, . . . 264, 268 to the customer-level data from step 232 and then appending the group-level data to the customer-level data. Matching may be done by the appropriate group variable. For example, if the group variable is zip code, all customer records with zip code 60640 may be augmented equally by the information on that zip code in the group-level data. This step can add a sizable number of variables to the predictor set. Moreover, the final data set may also contain the deviations of each customer from the group summary characteristics.

Continuing with process 100 illustrated in FIG. 1, a statistical algorithm may next be selected at step 120 so that this algorithm can be used to fit a model for predicting the target variable from the predictor variables at step 128. At least some embodiments of this invention may employ CART-style classification (discrete target) or regression (continuous target) trees as statistical algorithms. Possible choices also include but are not limited to neural networks, support vector machines, random forests or other non-parametric classification or regression algorithms. Where applicable, the statistical algorithm may include committee method techniques of combining multiple model fits, e.g., by bagging or boosting. There may be several considerations for the choice of a statistical algorithm. It preferably should easily accommodate a large number of predictor variables while maintaining a practical speed of execution. Furthermore, it preferably should detect and adjust for interaction effects between variables. This can be important, since interaction effects are common, and given the large number of variables, it is usually impractical to explicitly create these effects by combining appropriate variables. For example, classical logistic regression (without extensions or adjustments) may not be ideal for this process. A third consideration is that the algorithm preferably should provide a measure of variable importance. This can ease the computational burden of model fitting by allowing multi-step strategies. Lastly, if missing data is an issue for at least some of the predictor variables, it may be important to choose an algorithm that intelligently accommodates missing entries without eliminating valuable information.

Next, at step 128, a statistical model may be fit to the target variable. In at least some embodiments of this invention, this can be performed in one step by applying the algorithm straightforwardly or with the usual tweaks and parameter calibrations that skilled statisticians are familiar with. In other embodiments, to reduce computational cost and gain some insights, one may employ a multi-step strategy of variable selection. Such an approach fits the model independently with various subsets of predictor variables, where each predictor variable is present in at least one subset. Using the variable importance criterion of the algorithm, the most important variables may be chosen from each subset to form the set of predictor variables used in the next or final model fit. Sometimes, variable importance may be used again to further reduce the set of variables. Variations of this multi-step approach may be possible.

At step 124, customer-level predictor variables are obtained up to the current time (i.e., time t₀). These customer-level predictor variables may be obtained as described for step 112 above. Next, at step 132, the customers will be scored using the statistical model created at step 128 and predictor variables obtained at step 124. The resulting customer-level activity scores may be used to predict the target variable at the future time t₀+t_{F}.

Process 100 of FIG. 1 can be further described in connection with the following example.

Beginning at step 104, the forecast period t_{F} may be set to 12 months. This choice may avoid problems with seasonal effects and is a meaningful time period for most regular retail businesses. Note however that for t_{F}=12 months, it may be useful to have at least 24 months of customer and transactional history available (see considerations above). With 13-24 months of history, predictions are technically still possible, but their quality may suffer.

At step 108, the target variable may be chosen to be an indicator of customer activity in a 12-month period referred to as “activity12”. Acitvity12 may be set to “1” if the customer made, makes, or will make at least one purchase in the corresponding 12-month period, and activity12 may be set to “0” otherwise.

As described above, t₀ is the current time, which may be the last time with complete data refresh such as the end of the last month or the last week. At step 112, all customer-level variables may be compiled as detailed in FIG. 2 by using data up to time t₀−t_{F}, i.e., data going back 12 months. More specifically, as illustrated in FIG. 2 at steps 204-224, data from the demographics, account, cluster code and transaction files may be collected at data from steps 204-216. This data may be appropriately transformed, converted and used to create other data variables in step 232. In steps 236, 248, . . . 260, n=3 group variables may be defined to be: group 1=most popular store (specific store in department store chain where customer has highest spend), group 2=home address zip code, group 3=PERSONICX cluster. All customer variables from step 232 may be summarized (or rolled up) to each of these group variables at steps 244, 256, and 268, hence creating three new datasets, one store-level (one record per store), one zip code level, and one PERSONICX cluster level. External data about stores, zip codes, and PERSONICX clusters may also be obtained at steps 240, 252, and 264. For example, for each store, this external data may indicate the size (square feet of selling floor), the number of FTEs (full time employee equivalents) working there, and whether the store is in a mall or is a stand-alone store. These three variables (together with the store number) form another store-level dataset (summary group 1) at step 240. Likewise for zip codes, demographic data from the census bureau forms a zip code level dataset (summary group 2) at step 252. For each PERSONICX cluster, ACXIOM provides some summary data that forms a cluster-level dataset (summary group 3) at step 264. The final predictor variable set may then be created at step 272 by appending all the group level data sets (customer summary and external) to the customer-level variables. Hence, a large number of additional pieces of information may be appended to each customer. In addition, the final data set may also contain the deviations of each customer from the group summary characteristics. This final set is the result of step 112 in FIG. 1.

Our target variable, activity12 may be obtained for the current time to at step 116. This simply means that activity12=1 is assigned to every customer who has made a purchase in the last 12 months, and activity12=0 is assigned to all customers who have not.

CART (Classification and Regression Trees) may then be chosen as the statistical algorithm at step 120. CART was originally developed by Leo Breiman (Department of Statistics, University of California Berkeley) in 1984. It is now part of many software packages, e.g., the CART package by SALFORD SYSTEMS. Note that many other choices of algorithms and software packages may be used.

At step 128, the CART algorithm selects variables out of the predictor variable set that are significant for distinguishing between the levels of the target variable (whether customer was active or not), and ultimately constructs a complex formula that can assign a probability of activity (a number between 0 and 1) to each possible combination of the predictor variables. In practice, one may split up this data set (predictors up to past time with target of current time) into a training, a validation, and a testing set, where the first is used for model fitting (“growing” the tree in case of CART), the second for adjusting certain fitting parameters (“pruning” in case of CART) and the third for evaluating the true predictive characteristics of the final model (i.e., error rates).

Next, at step 124, the predictor variables may be compiled again, but now up to the current time (t₀), using the same process outlined before for step 112. This predictor variable data set may then be fed into the formula of the statistical model at step 132, to form a score for each customer (the number between 0 and 1). In this example this score is the predictive probability that the customer will make a purchase over the next 12 months. For example, a customer with a score of 0.9, has a “90% chance” of being active over the next year, whereas the customer with a score of 0.5 only has a “50% chance”.

Turning to FIG. 4, a process for marketing using the scores generated above is shown. As illustrated, a marketing strategy may first be determined at step 404. This strategy could be, for example, to target consumers with the highest likelihood to make a purchase within a certain time period. Step 408 then obtains corresponding activity scores for customers, e.g., as explained in process 100 of FIG. 1. In step 412, out of all available customers, those with scores corresponding best to the marketing strategy are selected. In at least some embodiments of this invention, it may be necessary to exclude certain groups of customers from the selection, e.g., customers within do-not-solicit or high-risk groups, or customers flagged for other business or regulatory reasons. Finally, direct marketing techniques may be applied to the selected customers at step 416.

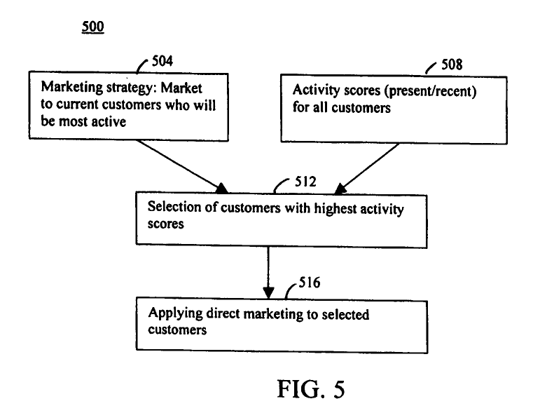

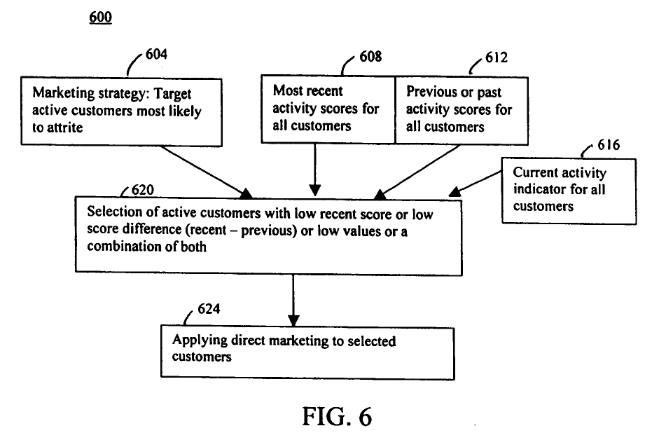

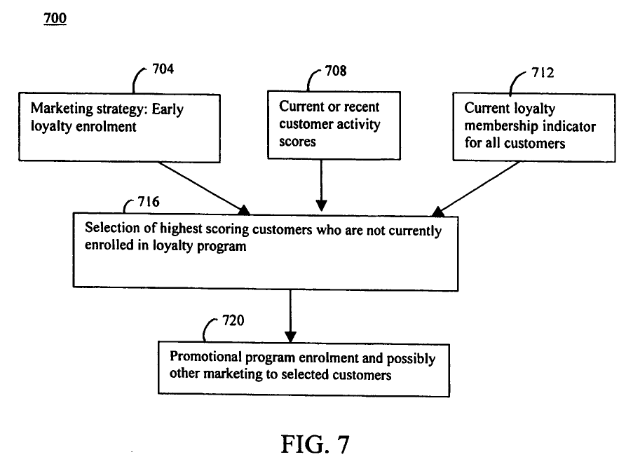

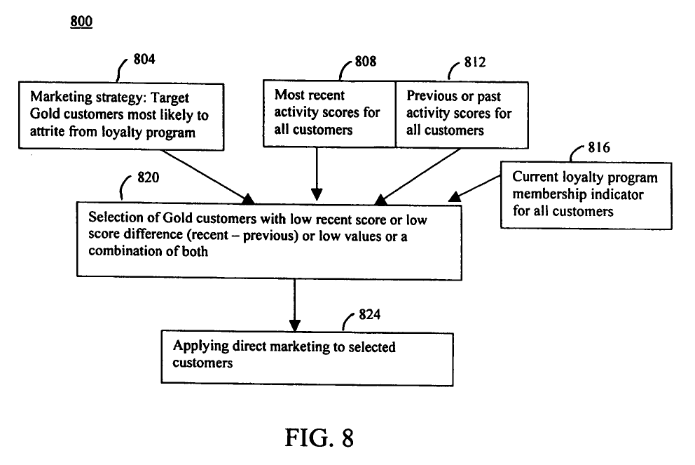

FIGS. 5-8 illustrate more specific examples of the general process shown in FIG. 4. For example, process 500 of FIG. 5 targets customers who will be most active, process 600 of FIG. 6 targets customers who are most likely to attrite, process 700 of FIG. 7 targets customers for early enrolment in a gold/rewards/loyalty program, and process 800 of FIG. 8 targets customers who are most likely to attrite from a gold/rewards/loyalty program.

More particularly, as shown in FIG. 5, process 500 begins at step 504 by setting the marketing strategy to marketing to customers who will be most active. Next, at step 508, the process considers activity scores for all customers, e.g., coming from process 100. In this case, the target variable (step 108) in the modeling process may be a flag for customer activity in a certain time period, the number of transaction, the number of purchase events or any other variable directly related to events indicating customer activity. The customers with the highest activity scores are then selected at step 512. Finally, direct marketing is applied to the selected customers at step 516.

Process 600, as shown in FIG. 6, begins at step 604 by setting the marketing strategy to marketing to customers who are most likely to attrite, i.e., an attrition prevention strategy. The most-recent activity scores for customers are then obtained at step 608 and past activity scores for the customers are obtained at step 612 (e.g., both through process 100). An activity indicator is also obtained for all customers at step 616. This indicator may give information of whether the customer can still be considered active and has not (silently or explicitly) attrited. In step 620, out of the customers still considered active, those with low recent scores, low score difference between recent and previous scores, or low values of a combination of the recent score and the difference may then be selected. The rationale is that these are active customers with a high potential of becoming inactive in the near future. Finally, direct marketing is applied to the selected customers at step 624.

Process 700, as shown in FIG. 7, begins at step 704 by setting the marketing strategy to early enrollment of certain customers into the loyalty program. Current or recent customer activity scores are then obtained at step 708 (e.g., through process 100), and current loyalty membership indicators for all customers are obtained at step 712. The loyalty indicator gives information on whether the customer is currently enrolled in the loyalty program. Next, the highest scoring customers who are not currently enrolled in a loyalty program are selected at step 716. Finally, the selected customers may be made eligible for promotional program enrolment, or may otherwise be marketed to at step 720.

Process 800, as shown in FIG. 8, begins at step 804 by setting the marketing strategy to marketing “Gold customers” (loyalty customers) who are most likely to attrite from a loyalty program, i.e. a loyalty attrition prevention strategy. Recent activity scores for all customers are then obtained at step 808 and previous or past activity scores for all customers are obtained at step 812 (e.g., both through process 100). An indicator of current loyalty program membership is also obtained at step 816. This indicator may give information of whether the customer can still be considered a loyalty/Gold/rewards member. In step 820, out of the customers still considered loyalty members, those with low recent scores, low score difference between recent and previous scores, or low values of a combination of the recent score and the difference may be selected. The rationale is that these are loyal customers with a high potential of becoming less loyal in the near future. Finally, direct marketing is applied to the selected customers at step 824.

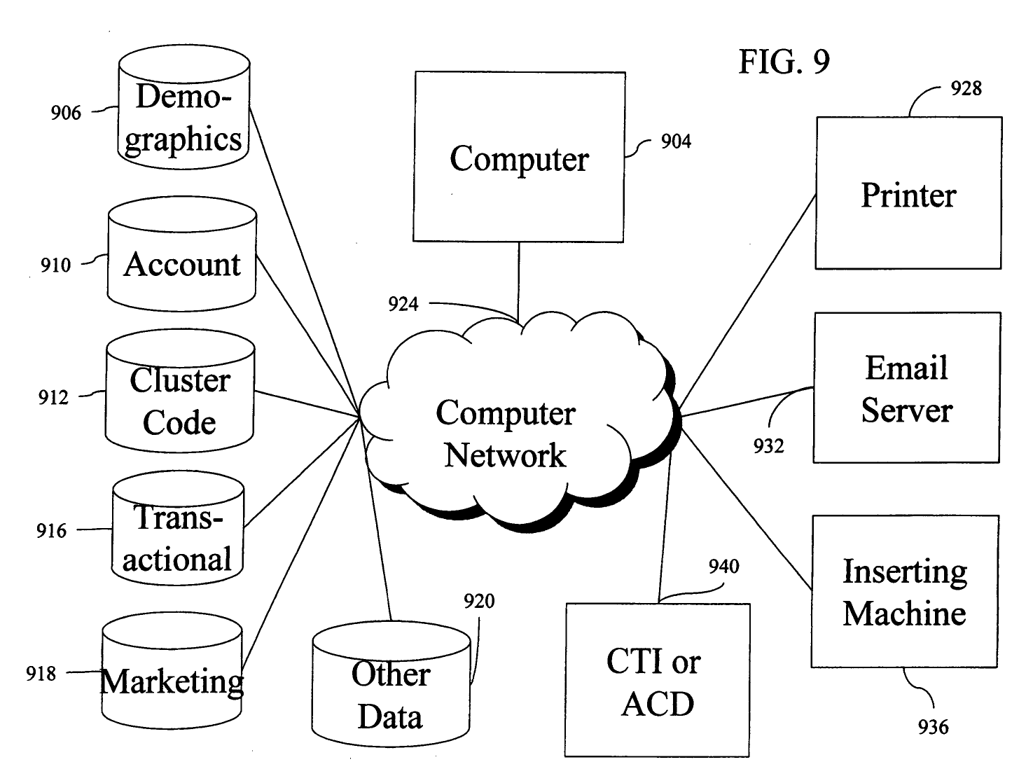

The processes described above in accordance with the present invention, as illustrated in FIG. 9, may be implemented in any suitable general or specific purpose computer 904, which may be connected to any suitable databases 906, 910, . . . 920 and/or output devices 928, 932, . . . 940 via any suitable connection or computer network 924, or combination of the same, such as the Internet. Data maintained in databases 906, 910, . . . 920 may correspond to the data collected at steps 204, 208, . . . 224, respectively. Any suitable database or data storage mechanisms may be used to implement databases 906, 910, . . . 920, and although illustrated in FIG. 9 as being separate, and of these databases may be combined if desired.

As described above, the resulting marketing indicators may be used to target marketing activity, and hence output devices may be used, for example, to generate mailing labels, to generate email or printed advertisements, to insert flyers into mailing (such as credit card statements), to route sales calls, etc. Thus, the output devices may include printers 928, email servers 932, inserting machines 936, telephone equipment 940 (e.g., computer telephony integration (CTI) or automatic call director (ACD)), or any other suitable equipment.

Although specific embodiments of the invention are described herein, it should be apparent to one of skill in the art that the present invention may be implemented with various alternatives within the spirit of the invention, and that the scope of the invention is limited only by the claims that follow.

What is claimed is:

1. A method for scoring customers for marketing, comprising:
collecting demographic data and transactional data for each of the customers;
summarizing at least one variable in the demographic data and/or the transactional data to form summary data, and attaching the summary data to each of the customers;
applying a statistical algorithm to the demographic data, the transactional data, and the summary data to create a model of a target variable related to customer activity and/or loyalty;
deriving a score for each of the customers from the model;
selecting at least some of the customers based on the score for each of the customers; and
marketing directly to the selected customers.

2. The method of claim 1, wherein the summary data comprises a mean of the at least one variable in the demographic data and/or the transactional data.

3. The method of claim 1, wherein the summary data comprises a median of the at least one variable in the demographic data and/or the transactional data.

4. The method of claim 1, wherein the summary data comprises a quantile of the at least one variable in the demographic data and/or the transactional data.

5. The method of claim 1, wherein the summary data comprises a standard deviation of the at least one variable in the demographic data and/or the transactional data.

6. The method of claim 1, wherein the summary data comprises the relative and/or absolute frequency of at least one value of at least one categorical and/or discrete variable in the demographic data and/or the transactional data.

7. The method of claim 6, further comprising aggregating values of the at least one categorical and/or discrete variable that are most infrequent into a separate category, and using the separate category instead of individual values to calculate the relative and/or absolute frequency.

8. The method of claim 1, further comprising calculating, for each of the customers, the deviation of the customer from the summary data.

9. The method of claim 1, wherein the target variable is binary and the score indicates the predicted probability of a binary event corresponding to the target variable.

10. The method of claim 9, wherein the binary event is one of: a customer showing activity in a given time period; a customer engaging in a given number of transactions in a given period; a customer spending a given amount in the given period, a customer making a given number of retail visits in the given period; a customer qualifying for a loyalty program; a customer showing purchase activity in a given period; and a customer purchasing or subscribing to a certain combination of products.

11. The method of claim 1, wherein the target variable is numeric and the score indicates the predicted value of the target variable.

12. The method of claim 11, wherein the target variable represents one of: the amount spent by a customer; the number of transactions engaged in by a customer; the number of products and/or subscriptions purchased by a customer; the number of visits to a retail location made by a customer; the number of visits by a customer to a Web site; the number of purchases by a customer of a least a certain amount.

13. The method of claim 1, wherein the summarizing is based on at least one group variable.

14. The method of claim 13, wherein the at least one group variable is external to the demographic data and/or the transactional data.

15. The method of claim 13, wherein the at least one group variable is in the demographic data and/or the transactional data.

16. The method of claim 13, wherein the at least one group variable comprises at least one of retail store, transaction location, home zip code, county, state, country, and a cluster code.

17. The method of claim 16, wherein the at least one group variable comprises the cluster code and the cluster code is one of ACXIOM'S PERSONICX, LOOKING GLASS' COHORTS, CLARITAS' PRISM, ESRI'S COMMUNITY, EXPERIAN'S MOSAIC, and MAPINFO'S PSYTE.

18. The method of claim 1, wherein the statistical algorithm includes combining multiple-model fits using a committee method.

19. The method of claim 18, wherein the committee method is one of bagging and boosting.

20. The method of claim 1, wherein the statistical algorithm is a parametric model.

21. The method of claim 20, wherein the parametric model is one of: a logistic regression model; a linear regression model; a non-linear regression model; a generalized linear model; generalized estimating equations; linear discriminant analysis; and quadratic discriminant analysis.

22. The method of claim 1, wherein the statistical algorithm is a non-parametric model.

23. The method of claim 22, wherein the non-parametric model is one of: a neural network; a support vector machine; a nearest neighbor model; a non-parametric regression model; a spline model; a kernel model; a patient rule induction method; and a tree algorithm.

24. The method of claim 23, wherein the non-parametric model is a tree algorithm and the tree algorithm is one of: CART, CHAID, TreeNet, and Random Forests.

25. The method of claim 1, wherein the marketing includes marketing customers who have been inactive for a given period.

26. The method of claim 1, wherein the marketing includes marketing customers eligible or nearly eligible for enrolment in a loyalty program.

27. The method of claim 1, wherein the marketing includes marketing customers likely to attrite from the active customer base or from a loyalty program.

28. The method of claim 1, wherein directly marketing includes marketing customers who are most likely to be active.

29. A system for scoring customers for marketing, comprising:
at least one database containing demographic data and transactional data for each of the customers;
a computer that:
receives from the at least one database the demographic data and the transactional data,
summarizes at least one variable in the demographic data and/or the transactional data to form summary data, and attaches the summary data to each of the customers,
applies a statistical algorithm to the demographic data, the transactional data, and the summary data to create a model of a target variable related to customer activity and/or loyalty, and
derives a score for each of the customers from the model;
selects at least some of the customers based on the score for each of the customers; and
markets directly to the selected customers.

30. The system of claim 29, wherein the summary data comprises a mean of the at least one variable in the demographic data and/or the transactional data.

31. The system of claim 29, wherein the summary data comprises a median of the at least one variable in the demographic data and/or the transactional data.

32. The system of claim 29, wherein the summary data comprises a quantile of the at least one variable in the demographic data and/or the transactional data.

33. The system of claim 29, wherein the summary data comprises a standard deviation of the at least one variable in the demographic data and/or the transactional data.

34. The system of claim 29, wherein the summary data comprises the relative and/or absolute frequency of at least one value of at least one categorical and/or discrete variable in the demographic data and/or the transactional data.

35. The system of claim 34, wherein the computer also aggregates values of the at least one categorical and/or discrete variable that are most infrequent into a separate category, and using the separate category instead of individual values to calculate the relative and/or absolute frequency.

36. The system of claim 29, wherein the computer also calculates, for each of the customers, the deviation of the customer from the summary data.

37. The system of claim 29, wherein the target variable is binary and the score indicates the predicted probability of a binary event corresponding to the target variable.

38. The system of claim 37, wherein the binary event is one of: a customer showing activity in a given time period; a customer engaging in a given number of transactions in a given period; a customer spending a given amount in the given period, a customer making a given number of retail visits in the given period; a customer qualifying for a loyalty program; a customer showing purchase activity in a given period; and a customer purchasing or subscribing to a certain combination of products.

39. The system of claim 29, wherein the target variable is numeric and the score indicates the predicted value of the target variable.

40. The system of claim 39, wherein the target variable represents one of: the amount spent by a customer; the number of transactions engaged in by a customer; the number of products and/or subscriptions purchased by a customer; the number of visits to a retail location made by a customer; the number of visits by a customer to a Web site; the number of purchases by a customer of a least a certain amount.

41. The system of claim 29, wherein the summarizing is based on at least one group variable.

42. The system of claim 41, wherein the at least one group variable is external to the demographic data and/or the transactional data.

43. The system of claim 41, wherein the at least one group variable is in the demographic data and/or the transactional data.

44. The system of claim 41, wherein the at least one group variable comprises at least one of retail store, transaction location, home zip code, county, state, country, and a cluster code.

45. The system of claim 45, wherein the at least one group variable comprises the cluster code and the cluster code is one of ACXIOM'S PERSONICX, LOOKING GLASS' COHORTS, CLARITAS' PRISM, ESRI'S COMMUNITY, EXPERIAN'S MOSAIC, and MAPINFO'S PSYTE.

46. The system of claim 29, wherein the statistical algorithm includes combining multiple-model fits using a committee method.

47. The system of claim 46, wherein the committee method is one of bagging and boosting.

48. The system of claim 29, wherein the statistical algorithm is a parametric model.

49. The system of claim 48, wherein the parametric model is one of: a logistic regression model; a linear regression model; a non-linear regression model; a generalized linear model; generalized estimating equations; linear discriminant analysis; and quadratic discriminant analysis.

50. The system of claim 29, wherein the statistical algorithm is a non-parametric model.

51. The system of claim 50, wherein the non-parametric model is one of: a neural network; a support vector machine; a nearest neighbor model; a non-parametric regression model; a spline model; a kernel model; a patient rule induction method; and a tree algorithm.

52. The system of claim 51, wherein the non-parametric model is a tree algorithm and the tree algorithm is one of: CART, CHAID, TreeNet, and Random Forests.

53. The system of claim 29, wherein the marketing includes marketing customers who have been inactive for a given period.

54. The system of claim 29, wherein the marketing includes marketing customers eligible or nearly eligible for enrolment in a loyalty program.

55. The system of claim 29, wherein the marketing includes marketing customers likely to attrite from the active customer base or from a loyalty program.

56. The system of claim 29, wherein directly marketing includes marketing customers who are most likely to be active.

57. A computer readable medium comprising instructions being executed by a computer, the instructions including a software application for scoring customers for marketing, the instructions for implementing the steps of:
collecting demographic data and transactional data for each of the customers;
summarizing at least one variable in the demographic data and/or the transactional data to form summary data, and attaching the summary data to each of the customers;
applying a statistical algorithm to the demographic data, the transactional data, and the summary data to create a model of a target variable related to customer activity and/or loyalty;
deriving a score for each of the customers from the model;
selecting at least some of the customers based on the score for each of the customers; and
marketing directly to the selected customers.

58. The medium of claim 57, wherein the summary data comprises a mean of the at least one variable in the demographic data and/or the transactional data.

59. The medium of claim 57, wherein the summary data comprises a median of the at least one variable in the demographic data and/or the transactional data.

60. The medium of claim 57, wherein the summary data comprises a quantile of the at least one variable in the demographic data and/or the transactional data.

61. The medium of claim 57, wherein the summary data comprises a standard deviation of the at least one variable in the demographic data and/or the transactional data.

62. The medium of claim 57, wherein the summary data comprises the relative and/or absolute frequency of at least one value of at least one categorical and/or discrete variable in the demographic data and/or the transactional data.

63. The medium of claim 62, further comprising the instructions for aggregating values of the at least one categorical and/or discrete variable that are most infrequent into a separate category, and using the separate category instead of individual values to calculate the relative and/or absolute frequency.

64. The medium of claim 57, further comprising calculating, for each of the customers, the deviation of the customer from the summary data.

65. The medium of claim 57, wherein the target variable is binary and the score indicates the predicted probability of a binary event corresponding to the target variable.

66. The medium of claim 65, wherein the binary event is one of: a customer showing activity in a given time period; a customer engaging in a given number of transactions in a given period; a customer spending a given amount in the given period, a customer making a given number of retail visits in the given period; a customer qualifying for a loyalty program; a customer showing purchase activity in a given period; and a customer purchasing or subscribing to a certain combination of products.

67. The medium of claim 57, wherein the target variable is numeric and the score indicates the predicted value of the target variable.

68. The medium of claim 67, wherein the target variable represents one of: the amount spent by a customer; the number of transactions engaged in by a customer; the number of products and/or subscriptions purchased by a customer; the number of visits to a retail location made by a customer; the number of visits by a customer to a Web site; the number of purchases by a customer of a least a certain amount.

69. The medium of claim 57, wherein the summarizing is based on at least one group variable.

70. The medium of claim 69, wherein the at least one group variable is external to the demographic data and/or the transactional data.

71. The medium of claim 69, wherein the at least one group variable is in the demographic data and/or the transactional data.

72. The medium of claim 69, wherein the at least one group variable comprises at least one of retail store, transaction location, home zip code, county, state, country, and a cluster code.

73. The medium of claim 72, wherein the at least one group variable comprises the cluster code and the cluster code is one of ACXIOM'S PERSONICX, LOOKING GLASS' COHORTS, CLARITAS' PRISM, ESRI'S COMMUNITY, EXPERIAN'S MOSAIC, and MAPINFO'S PSYTE.

74. The medium of claim 57, wherein the statistical algorithm includes combining multiple-model fits using a committee method.

75. The medium of claim 74, wherein the committee method is one of bagging and boosting.

76. The medium of claim 57, wherein the statistical algorithm is a parametric model.

77. The medium of claim 76, wherein the parametric model is one of: a logistic regression model; a linear regression model; a non-linear regression model; a generalized linear model; generalized estimating equations; linear discriminant analysis; and quadratic discriminant analysis.

78. The medium of claim 57, wherein the statistical algorithm is a non-parametric model.

79. The medium of claim 78, wherein the non-parametric model is one of: a neural network; a support vector machine; a nearest neighbor model; a non-parametric regression model; a spline model; a kernel model; a patient rule induction method; and a tree algorithm.

80. The medium of claim 79, wherein the non-parametric model is a tree algorithm and the tree algorithm is one of: CART, CHAID, TreeNet, and Random Forests.

81. The medium of claim 57, wherein the marketing includes marketing customers who have been inactive for a given period.

82. The medium of claim 57, wherein the marketing includes marketing customers eligible or nearly eligible for enrolment in a loyalty program.

83. The medium of claim 57, wherein the marketing includes marketing customers likely to attrite from the active customer base or from a loyalty program.

84. The medium of claim 57, wherein directly marketing includes marketing customers who are most likely to be active.
